(19) United States
(12) Patent Application Publication
(10) Pub. No.: US 2002/0059093 A1
(43) Pub. Date: May 16, 2002

(54) Methods and systems for compliance program assessment

(76) Inventors: Nancy E. Barton, Old Greenwich, CT (US); David E. Tucker, Ridgefield, CT (US); Edward S. Gilbert, New York, NY (US); Robert C. Green, Newton, PA (US); Eugene F. Mensching JR., White Plains, NY (US); William Lacey, Cleveland, OH (US); Ligia B. Vicente, Bridgeport, CT (US); John M. Whitcomb, Tiburon, CA (US); Christina E. Mitchell, Bellevue, WA (US); John W. Carbone, Niskayuna, NY (US); Christopher Robine, Fairfield, CT (US); Sheri F. West, Norwalk, CT (US); Brackett B. Denniston III, Fairfield, CT (US); Frank Torres III, Phillipsburg, NJ (US)

Correspondence Address: John S. Beulick, Armsrtong Teasdale LLP, Suite 2600, One Metropolitan Sq., St. Louis, MO, 63102, US

(21) Appl. No.: 09/848,051

(22) Filed: May 3, 2001

Related U.S. Application Data
(60) Provisional application No. 60/202,165, filed on May 4, 2000.

(51) Int. Cl. G06F 17/60

(52) U.S. Cl. 705/10

(57) ABSTRACT

Methods and systems for identifying and quantifying compliance issues are described. In one embodiment, a system is configured to implement a method which comprises assessing at least one compliance program to identify potential risks and prioritizing the potential risks. The issues relating to the potential risks, for example, failure modes and root causes are identified and are mitigated and controlled.

### CROSS REFERENCE TO RELATED APPLICATIONS

This application claims the benefit of U.S. Provisional Application No. 60/202,165, filed May 4, 2000, which is hereby incorporated by reference in its entirety.

### BACKGROUND OF THE INVENTION

This invention relates generally to company policy compliance monitoring and, more particularly, to systems and methods for assessing compliance with company policies and risk prioritization.

Companies typically have policies and procedures that company employees are to conform within day to day business operations. Such policies sometimes are maintained in paper form and are accessible to employees through manager's offices and possibly at other locations in the business offices.

Although compliance with such policies and procedures is important for success of the company, until now, there generally has not been a methodology nor system which assesses the extent of compliance with such policies and procedures. In addition, there is no known formal measurement for assisting in determining the extent of risk associated with non-conformance.

Rather, in the past, companies typically would conduct an annual training session. The usefulness of the training and the extent of information disseminated as a result of such training was largely dependent upon the knowledge and experience of those employees responsible for the training within that particular organization. As a result, and especially in large multi-national companies, there may be variation in company policy training and monitoring from business to business.

In addition, when a company acquires another company, the acquiring company often implements its policies and procedures at the acquired company. The training sessions at such acquired companies typically are conducted shortly after completion of the acquisition, and company policy compliance monitoring is delegated to employees on site with the acquired company. Without a measurement system in place, however, the only data related to the effectiveness and speed at which the policies and procedures are being implemented is qualitative.

### BRIEF SUMMARY OF THE INVENTION

The present invention facilitates proactive monitoring and measuring of compliance with company policies so that appropriate action can be taken to avoid an occurrence of non-compliance. In one aspect, a method is provided for conducting a consistent, documented and yet repeatable compliance risk assessment and mitigation process. The method can be practiced using a network-based system including a server system coupled to a centralized database and at least one client system. The method comprises the steps of conducting a compliance program assessment, conducting a prioritization of compliance risks, identifying potential compliance failures including causes and effects and ensuring that risk monitoring and control mechanisms are in place to mitigate compliance risks.

In another aspect, a system is provided for automated assessment with compliance programs and prioritization of risk. In an exemplary embodiment, the system includes at least one computer coupled to a server through a network. The server is configured to assess at least one compliance program and prioritize the risk. The system server is further configured to identify issues relating to the risk, and for mitigation and control to resolve the issues.

In still another aspect, a computer is provided which is programmed to prompt a user to identify potential risks and failure modes and root causes associated with the risks within a compliance program, prioritize the risks, and prompt the user with at least one mitigation plan to deal with the identified risks and issues.

In yet another aspect, a computer program is provided which is stored on a computer readable medium for managing compliance risk assessment to enable businesses to develop broader and deeper coverage of compliance risks. The computer program controls a computer to generate a questionnaire based on a list of compliance requirements and store the questionnaire into a centralized database, record and process qualitative responses against each of the questions identified in the questionnaire, and convert the qualitative responses to quantitative results based on pre-determined criteria and generate a compliance risk assessment to enable businesses to reduce risks and improve profits.

In another aspect, a database is provided which includes data corresponding to identified potential risks, data corresponding to prioritization of the risks and data corresponding to a mitigation and control plan.

In another aspect, a method for compliance assessment is provided which includes entering, into an electronic interface, identified compliance risks and failure modes and root causes associated with the compliance risks, entering, into the electronic interface, compliance requirements, and requesting, from the electronic interface, a mitigation and control plan.

In yet another aspect, a system configured for compliance assessment is provided. The system comprises at least one computer, and a server configured to generate a questionnaire. The questionnaire includes a plurality of binary questions relating to a compliance program and a definition of what constitutes an affirmative answer to the questions to identified process owners. The server compiles answers received from the process owners, and summarizes the questions and answers as an assessment of the compliance program. The computer and the server are connected through a network. Various user interfaces allow process owners and members of a cross functional team to enter information relating to a compliance assessment.

In another aspect, a method is provided for compliance program assessment. The method comprises the steps of assembling a cross-functional team for determining what constitutes compliance, creating a questionnaire relating to compliance and defining what constitutes an affirmative answer to the questions, identifying and interviewing process owners for compliance with the compliance program, compiling interview results, and summarizing the results as an assessment of the compliance program.

### BRIEF DESCRIPTION OF THE DRAWINGS

FIG. 1 is a system block diagram.

FIG. 2 is a diagram of a network-based system.

FIG. 3 is a flow chart showing executed process steps.

FIG. 4 is a diagram listing action items to be taken based on an answer to a question.

FIG. 5 is a question owner's matrix.

FIG. 6 is a spreadsheet containing a questionnaire template.

FIG. 7 is a questionnaire metrics chart.

FIG. 8 is a compliance program assessment summary chart.

FIG. 9 is a policy assessment summary chart.

FIG. 10 is a high-level business risk model.

FIG. 11 is a severity matrix chart.

FIG. 12 is a risk Quality Function Deployment (QFD) matrix.

FIG. 13 is a risk Quality Function Deployment (QFD) matrix including a QFD score.

FIG. 14 is a flowchart showing a risk identification process.

FIG. 15 is a process map showing business process steps.

FIG. 16 is a chart of a failure mode and effects analysis (FMEA).

FIG. 17 is a policy scorecard.

FIG. 18 is a mitigation and control process flowchart.

FIG. 19 is an action items checklist.

FIG. 20 is an embodiment of a risk dashboard.

### DETAILED DESCRIPTION OF THE INVENTION

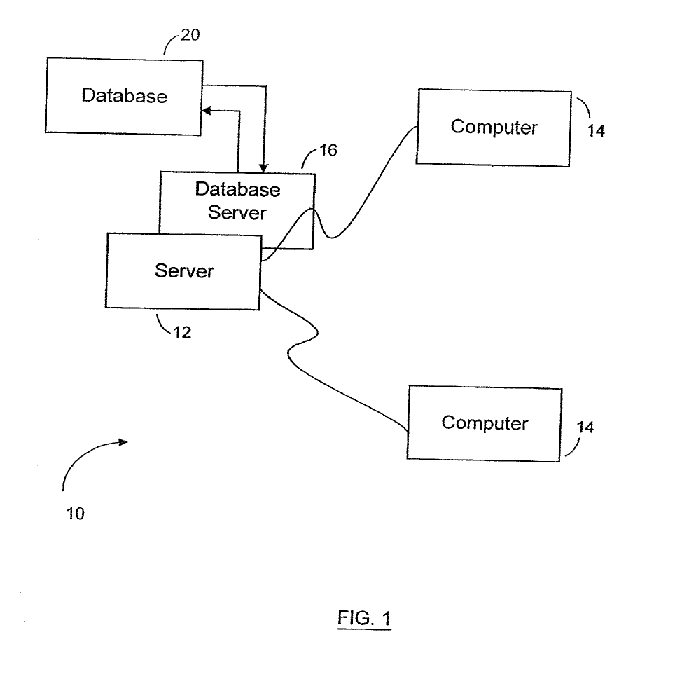

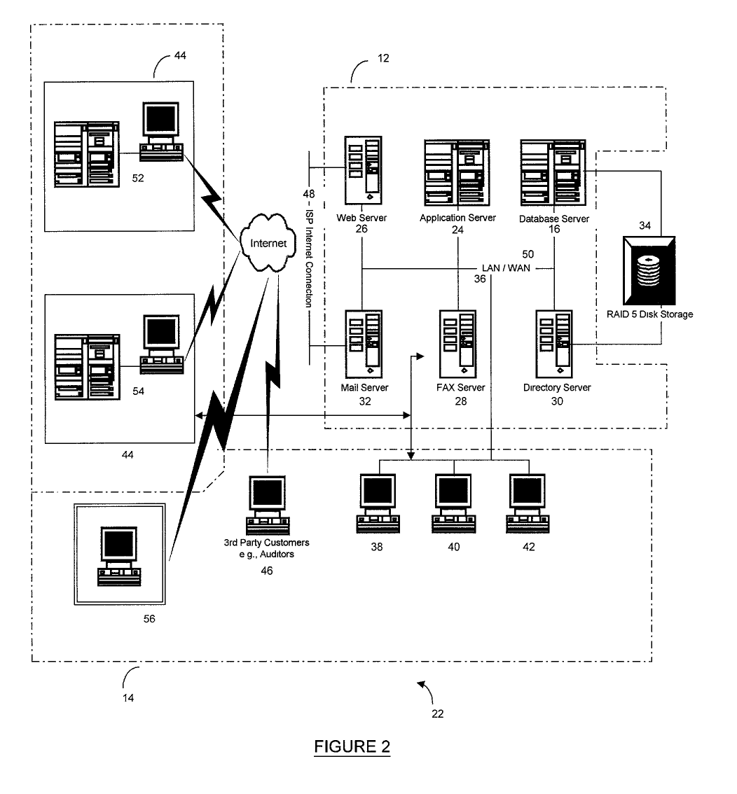

Set forth below are an overview of a Compliance Operating Model (COM), examples of hardware architectures (FIGS. 1 and 2) on which a COM can be stored and utilized, and examples of charts and scorecards utilized in connection with the COM.

Overview

A Compliance Operating Model (COM) is a compliance method, part of a Six Sigma initiative, to improve customer satisfaction and enhance shareholder values by reducing potential risks to the business. Six Sigma is a highly disciplined process that helps the business focus on developing and delivering near-perfect products and services. The COM is a method for conducting a consistent, documented and repeatable compliance risk assessment and mitigation process, with several tools and techniques to assess, identify, prioritize, mitigate and control compliance risks. All of the components together constitute an integrated Compliance Management System (CMS). The individual components of the CMS are separate processes that can be implemented by various functional organizations to achieve the broader objectives of compliance management.

Components of the COM, in an exemplary embodiment, are: a method for conducting a compliance program assessment, a method for conducting a prioritization of compliance risks, a method for identifying, for each risk area, the potential compliance failures and the potential causes and effects of such failures, and a method for ensuring that risk monitoring and control mechanisms are in place to mitigate compliance risks.

In an exemplary embodiment, compliance program assessment is a method for assessing the overall “infrastructure” or “process” elements of an effective compliance program and a method for assessing the key elements of compliance with a predetermined set of legal, regulatory and/or other requirements of a business. The elements that are being assessed through compliance program assessment include, but not limited to, are leadership commitment, training, resources, discipline and enforcement.

Compliance program assessment benchmarks the existing compliance program, identifies improvement opportunities and also identifies potential best practices. Potential best practices are business processes that are proven successful in the past and are worth repeating to achieve on-going business objectives. In an exemplary embodiment, the compliance program assessment is led by a legal counsel with execution by functional managers who are specialized in ensuring compliance with predetermined criteria for their individual functional specialty. Although specific embodiments of methods and systems for assessing compliance are described herein, the methods and systems are not limited to such particular exemplary embodiments.

Benchmarking the existing compliance program includes Assembling a cross functional team, Defining what constitutes a “yes” answer for key questions that are important to meet compliance requirements, Identifying and interviewing functional specialists, Compiling interview results, and Summarizing findings and reviewing final results with senior management.

To implement a successful COM, the business need to implement other components of COM successfully. Components of the CMS, as described above, are a method for conducting a prioritization of compliance risks, also referred to as “Risk Prioritization”, a method for identifying, for each risk area, the potential compliance failures and the potential causes and effects of such failures also referred to as “Issue Identification”, and a method for ensuring that risk monitoring and control mechanisms are in place to mitigate compliance risks, also referred to as “Mitigation & Control”.

Risk Prioritization involves identifying the compliance risks of a particular business's processes, products, environment, location, etc. and prioritizing the highest risks. In an exemplary embodiment, risk prioritization is a method for assessing the business's compliance risks, relating to business' processes, products and environment and identifying and prioritizing the business' highest risks.

Issue Identification involves conducting a more detailed review of the highest risk areas, to identify the potential compliance failures and the causes and effects of such failures. Issue Identification, in an exemplary embodiment, includes analyzing identified high risk areas to determine potential failures and root causes, prioritizing actions that need to be taken; and developing policy criteria, also referred to as policy scorecards to be used as a monitoring and reporting tool.

Mitigation & Control involves ensuring that appropriate controls are established and monitored to mitigate compliance risks. In an exemplary embodiment, Mitigation & Control includes developing action items and ensuring that the developed action items are completed in a timely manner, and establishing proper controls in place with some independent monitoring of the proper controls.

Hardware Architecture

FIG. 1 is a block diagram of a system 10 that includes a server sub-system 12, sometimes referred to herein as server 12, and a plurality of devices 14 connected to server 12. In one embodiment, devices 14 are computers including a web browser, and server 12 is accessible to devices 14 via a network such as an intranet or a wide area network such as the Internet. In an alternative embodiment, devices 14 are servers for a network of user devices.

Server 12 is configured to assess compliance, prioritize risk, benchmark existing programs, identify improvement opportunities, and identify potential best practices as part of a compliance program. A user interface allows a user to input data relating to the identification and quantification of a company's compliance process and to receive identification and quantification of compliance output. A computer-based compliance identification and quantification tool, as described below in more detail, is stored in server computer 12 and can be accessed by a requester at any one of computers 14.

Devices 14 are interconnected to the network, such as a local area network (LAN) or a wide area network (WAN), through many interfaces including dial-in-connections, cable modems and high-speed lines. Alternatively, devices 14 are any device capable of interconnecting to a network including a web-based phone or other web-based connectable equipment. Server 12 includes a database server 16 connected to a centralized database 18. In one embodiment, centralized database 18 is stored on database server 16 and is accessed by potential users at one of user devices 14 by logging onto server sub-system 12 through one of user devices 14. In an alternative embodiment centralized database 18 is stored remotely from server 12. In an exemplary embodiment, data from database 18 is checked out to an individual personal digital assistant (PDA), a handheld device that combines computing, telephone/fax, and networking features. Once the data has been modified through a PDA, the data can be re-checked into database 18 from the PDA.

In an exemplary embodiment, the CMS application is web enabled and is run on a business entity's intranet. In a further exemplary embodiment, the application is fully accessed by individuals having authorized access outside the firewall of the business entity through the Internet. In another exemplary embodiment, the application is run in a windows NT environment or simply on a stand alone computer system. In yet another exemplary embodiment, the application is practiced by simply utilizing spreadsheet software or even through manual process steps. The application is flexible and designed to run in various different environments without compromising any major functionality.

FIG. 2 is a block diagram of a network based system 22. System 22 includes server sub-system 12 and user devices 14. Server sub-system 12 includes database server 16, an application server 24, a web server 26, a fax server 28, a directory server 30, and a mail server 32. A disk storage unit 34 incorporating a computer-readable medium is coupled to database server 16 and directory server 30. Servers 16, 24, 26, 28, 30, and 32 are coupled in a local area network (LAN) 36. In addition, a system administrator work station 38, a work station 40, and a supervisor work station 42 are coupled to LAN 36. Alternatively, work stations 38, 40, and 42 are coupled to LAN 36 via an Internet link or are connected through an intranet.

Each work station 38, 40, and 42 is a personal computer including a web browser. Although the functions performed at the work stations typically are illustrated as being performed at respective work stations 38, 40, and 42, such functions can be performed at one of many personal computers coupled to LAN 36. Work stations 38, 40, and 42 are illustrated as being associated with separate functions only to facilitate an understanding of the different types of functions that can be performed by individuals having access to LAN 36.

Server sub-system 12 is configured to be communicatively coupled to various individuals or employees 44 and to third parties, e.g., user, 46 via an ISP Internet connection 48. The communication in the embodiment described is illustrated as being performed via the Internet, however, any other wide area network (WAN) type communication can be utilized in other embodiments, i.e., the systems and processes are not limited to being practiced via the Internet. In addition, and rather than a WAN 50, local area network 36 could be used in place of WAN 50.

In the embodiment described, any employee 44 or user 46 having a work station 52 can access server sub-system 12. One of user devices 14 includes a work station 54 located at a remote location. Work stations 52 and 54 are personal computers including a web browser. Also, work stations 52 and 54 are configured to communicate with server sub-system 12. Furthermore, fax server 28 communicates with employees 44 and users 46 located outside the business entity and any of the remotely located customer systems, including a user system 56 via a telephone link. Fax server 28 is configured to communicate with other work stations 38, 40, and 42 as well.

In an exemplary embodiment, at least one compliance program is assessed and the risks are prioritized. The issues relating to the risk, for example, determination of potential failures and root causes of the failures, are identified and resolved using mitigation and control. Metrics relating to training also are monitored.

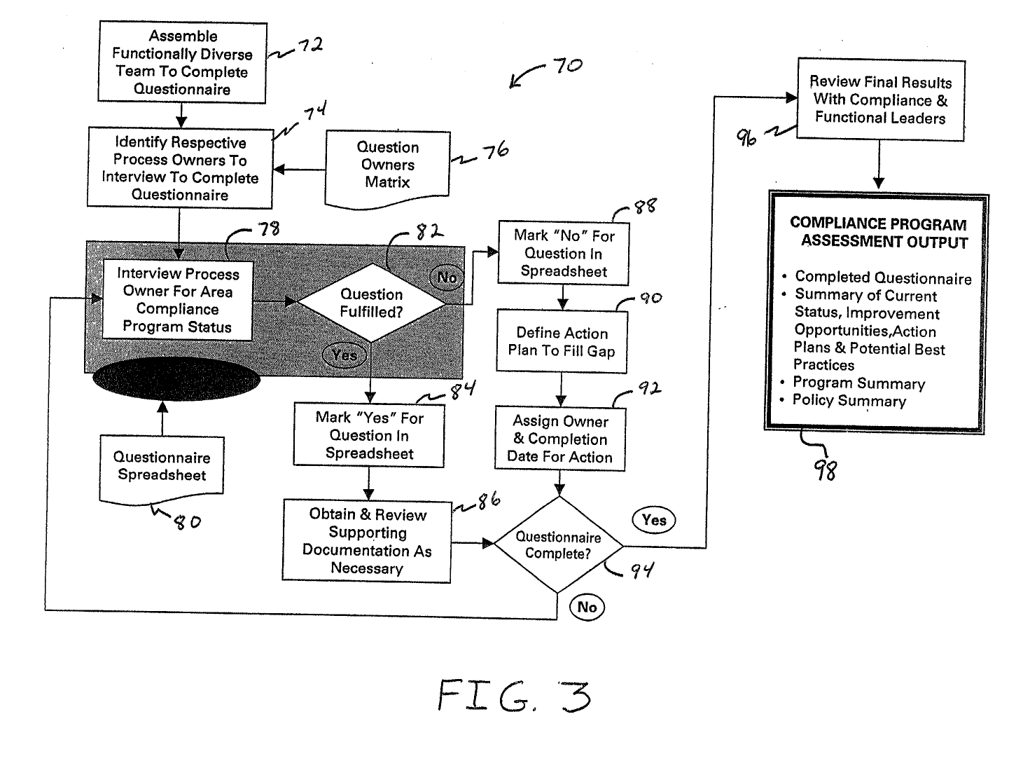

Assessment of a compliance program is used to benchmark existing programs, identify improvement opportunities and identify potential best practices. Referring to FIG. 3, a flowchart 70 for process steps executed in assessing at least one compliance program is shown. More specifically, server 12 (shown in FIGS. 1 and 2) is configured to facilitate steps described in FIG. 3. First, a cross-functional team is assembled 72 to determine what constitutes compliance. The cross-functional team may have members from all functional areas of a business having knowledge of compliance policies and how they relate to their function area. The cross-functional team is assembled 72 using a knowledge base which is stored on server 12 and may include any information relevant to the assembly 72 of a cross-functional team.

Respective process owners are identified 74 for interviews during which a questionnaire regarding compliance is completed. The identification 74 of the process owner is conducted using the knowledge base, which also includes any information relevant to identifying 74 interviewees. Accordingly, and in one embodiment, the knowledge base includes a question owner's matrix 76.

In one embodiment, server 12 is configured to use the knowledge base to determine what constitutes an affirmative answer to a question in the questionnaire. Compliance is largely dependent upon the particular circumstances of each business. Accordingly, the knowledge base may include, for example, information from compliance leaders and information relevant to each business and for each environment. The knowledge base may also include standards for minimum program qualities and the level of documentation required for proof in answering the question which sets a standard used as a guide through the interviews with process owners.

Interviews 78 are conducted with process owners for area compliance program status. As used herein interviewing means receiving information. Interviewing includes receiving information via a questionnaire, which may be stored within server 12 as part of the knowledge base. As described above, the knowledge base is stored in a central database within server 12 and may include a questionnaire spreadsheet 80.

During the interview 78, if a question is fulfilled 82, “yes” is marked 84 on the questionnaire spreadsheet. Then, supporting documentation is obtained and reviewed 86, if necessary If a question is not fulfilled 82, a “no” answer is marked 88 for the question in the questionnaire spreadsheet. If a “no” answer is marked 88 an action to fill the gap is defined 90 and an owner and a completion date for the action are assigned 92 by system 10. When the questionnaire is complete 94, the results are reviewed 96, typically with functional leaders. If the questionnaire is not complete 94, process owners are interviewed 78 again for compliance program status. In one exemplary embodiment, questions on the questionnaire have two possible answer choices—“yes”, and “no”. In another exemplary embodiment, questions on the questionnaire have three possible answer choices—“yes”, “no” and “not applicable”. In yet another embodiment, instead of “yes” or “no”, there could be “high” or “low” or a scale of one to ten or other similar numerical scale for receiving answers.

System 10 outputs 98 at least one of a completed questionnaire, a summary of current status, improvement opportunities, action plans and potential best practices, program summary and policy summary.

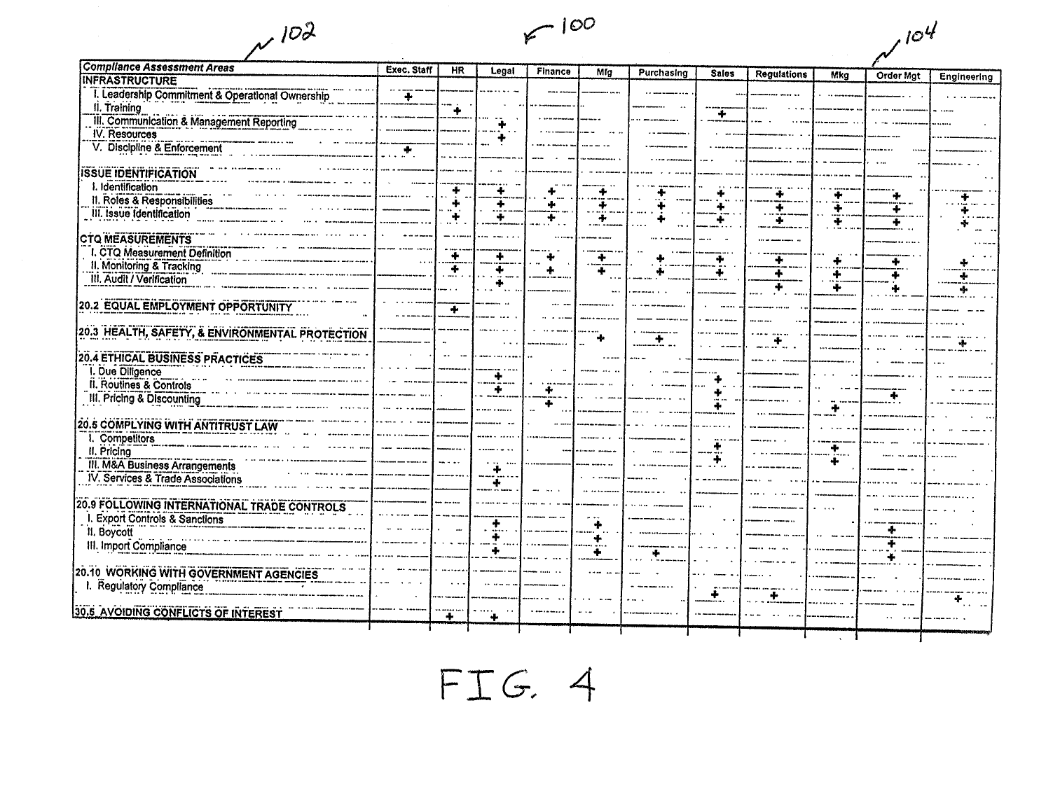

In one embodiment, interviews 78 (shown in FIG. 3) are conducted in accordance with a question owner's matrix. More specifically, FIG. 4 shows one embodiment of a question owner's matrix 100. A question owner's matrix 100 is used as a guideline for identifying an interviewee for each sub-group of questions. The question owner's matrix 100 is constructed using the knowledge base within server 12. The knowledge base may include any information relevant to conducting an interview relating to compliance. The knowledge base may include, for example, information associating a group of questions with relevant functional knowledge, a summary of the details of program current status, improvement opportunities, identification of action item owners and a list of potential best practices. The question owner's matrix 100 lists compliance assessment areas 102. Compliance assessment areas 102 are any areas of a business that are being reviewed for compliance. Examples of compliance assessment areas 102 include, but are not limited to infrastructure, equal employment opportunity, antitrust, trade controls, ethical business practices and supplier relationships. The question owner's matrix 100 may also identify potential interviewees 104 by function for each area assessment using the knowledge base. Examples of interviewees 104 include, but are not limited to engineering, marketing, manufacturing, legal, purchasing, finance, and human resources.

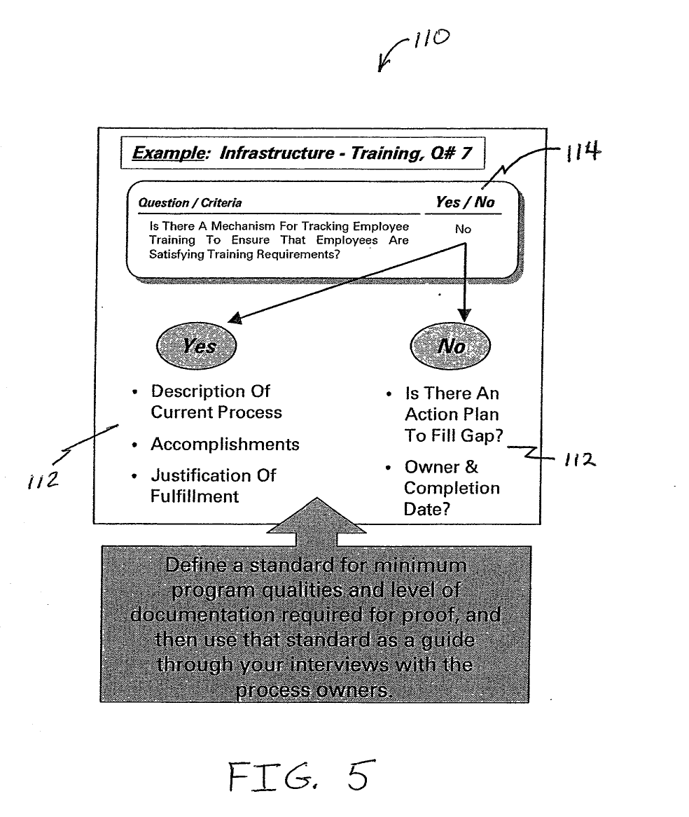

In one specific embodiment, different action items for an affirmative answer and for a negative answer to the questionnaire are set forth on a diagram. Specifically, FIG. 5 is one embodiment of a diagram 110 that lists different action items 112 for an affirmative or negative answer to a particular question 114 within the questionnaire. For example, if the user answers “yes” to whether there is a mechanism for tracking employee training to ensure that employees are satisfying training requirements, system 10 (shown in FIG. 1) presents action items 112 relating to the description of the current process, accomplishments and justification of fulfillment. If the user answers negatively, system 10 presents action items 112 relating to whether there is an action plan to fill the gap, who is the owner and what is the completion date.

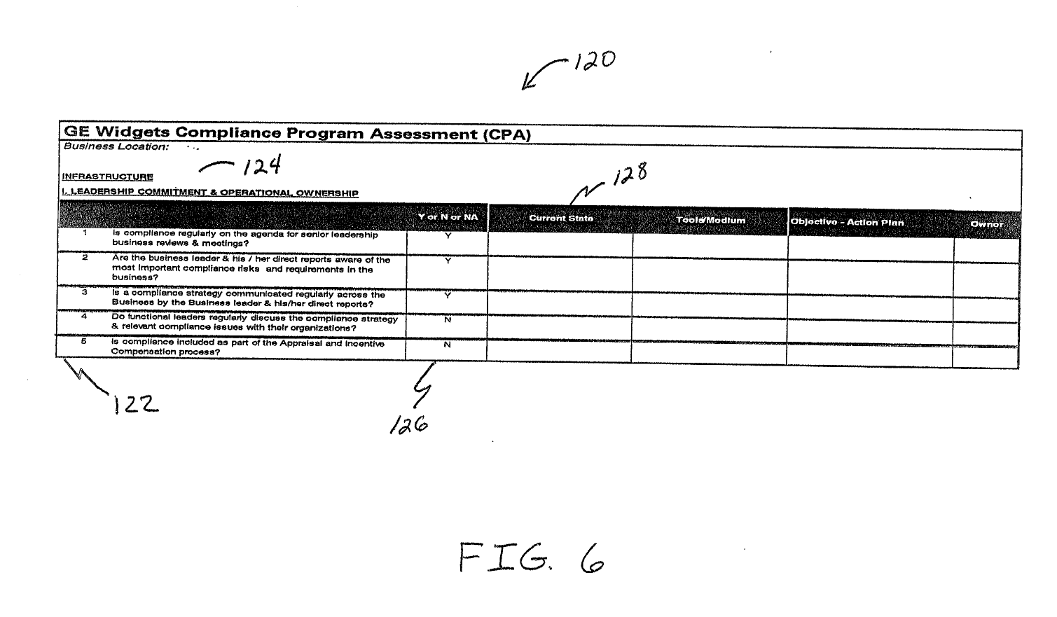

In one embodiment, interview results are compiled using a questionnaire template spreadsheet. FIG. 6 illustrates one embodiment of a questionnaire template spreadsheet 120. The interview questions 122 asked for each compliance assessment area 124 are entered into template 120. Answers 126 to the questions are also entered into template 120. Template 120 is stored in server 12, and using hidden columns, server 12, automatically converts the qualitative results on the spreadsheet to quantitative results. For example, an affirmative answer is automatically converted to a numerical entry of “1”. Qualitative answers 128 that are collected during interviews are also input into template 120. Qualitative answers 128 may include, for example, current program details, tools used, action plans, owner, completion date and best practices. In another specific embodiment, an answer 126 of “not applicable” triggers a switch to indicate that a question should not be added into the count in the analysis of the results.

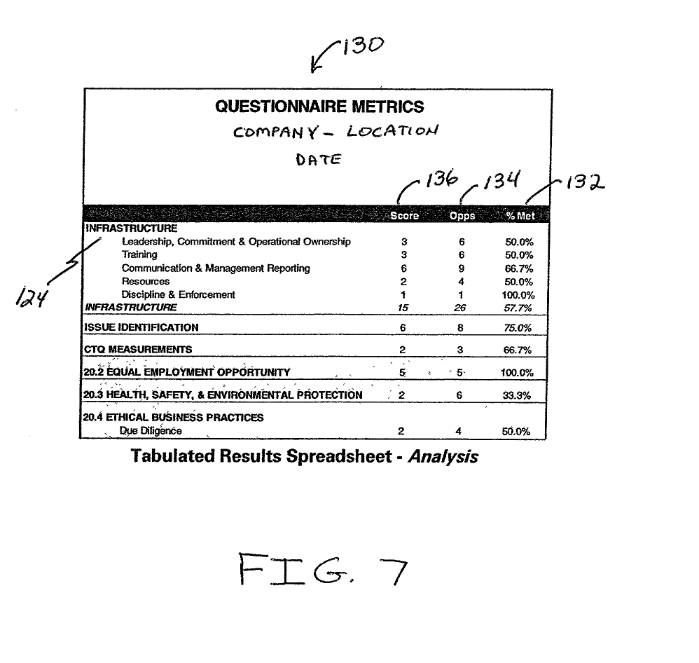

Server 12 is also configured to add the “ones” of the affirmative answers and to tabulate and graph the results automatically when commanded, typically by a functional or compliance leader. Specifically, FIG. 7 is an embodiment of a questionnaire metrics chart 130 generated using answers 126 entered into template 120 (shown in FIG. 6). Questionnaire metrics chart 130 includes, for example, the percent of compliance 132 in each compliance assessment area 124. Percent of compliance 132 is the ratio of the number of questions for which an answer was expected 134, also called “Opps” for opportunities and a score 136, which is the total number of “ones” in a particular compliance assessment area 124.

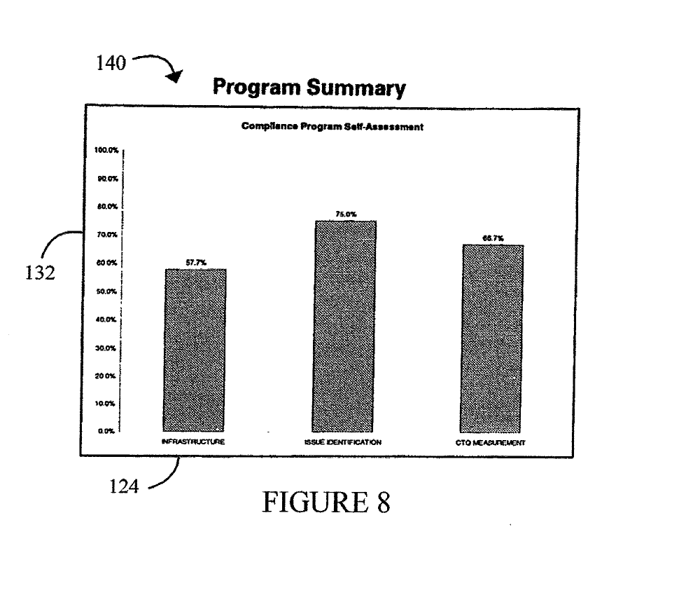

Server 12 (shown in FIGS. 1 and 2) summarizes the results of the assessment of the compliance program by automatically converting questionnaire metrics chart 130 (shown in FIG. 7) to a compliance program assessment summary chart when instructed to do so by a functional or compliance leader. One embodiment of a compliance program assessment summary chart 140 is shown in FIG. 8. The program assessment summary 140 includes, for example, the percent of compliance 132 by compliance assessment area 124, progress since the last review, focus areas for the next review and a comparison of criteria based on business risk and environment.

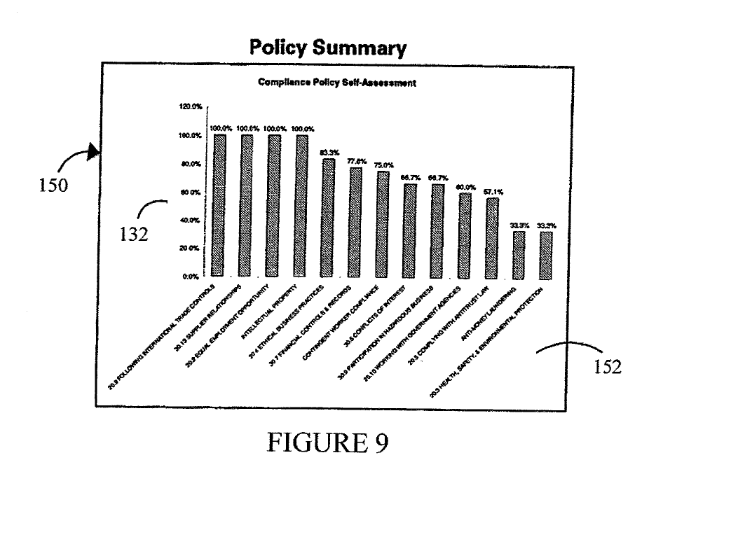

Server 12 is further configured to respond to a request to summarize the assessment results of the compliance program by converting questionnaire metrics chart 130 (shown in FIG. 7) to a policy assessment summary. One embodiment of a policy assessment summary chart 150 is shown in FIG. 9. Policy assessment summary chart 150 includes, for example, the percent of compliance 132 by policy assessment area 152.

In addition, risks are prioritized. Resources used to prioritize risk may include functional leaders, compliance leaders, compliance experts, policy owners, a management team, and legal counsel. Risk prioritization is used to assess the compliance risk, relating the risk to processes, products and environments and identifying and prioritizing the highest risk(s). Prioritization of the risk(s) is performed by mapping a high-level risk model and compiling a list of compliance requirements. Next, the list of compliance requirements is prioritized and construction of a quality function deployment (QFD) matrix is started using system 10. A severity rating for non-compliance with the requirements is entered by a designee of the resource team listed above, and the compliance policies are assessed and valuated. Finally, the immediate risks are identified, construction of the QFD matrix is completed and the compliance risk areas are prioritized.

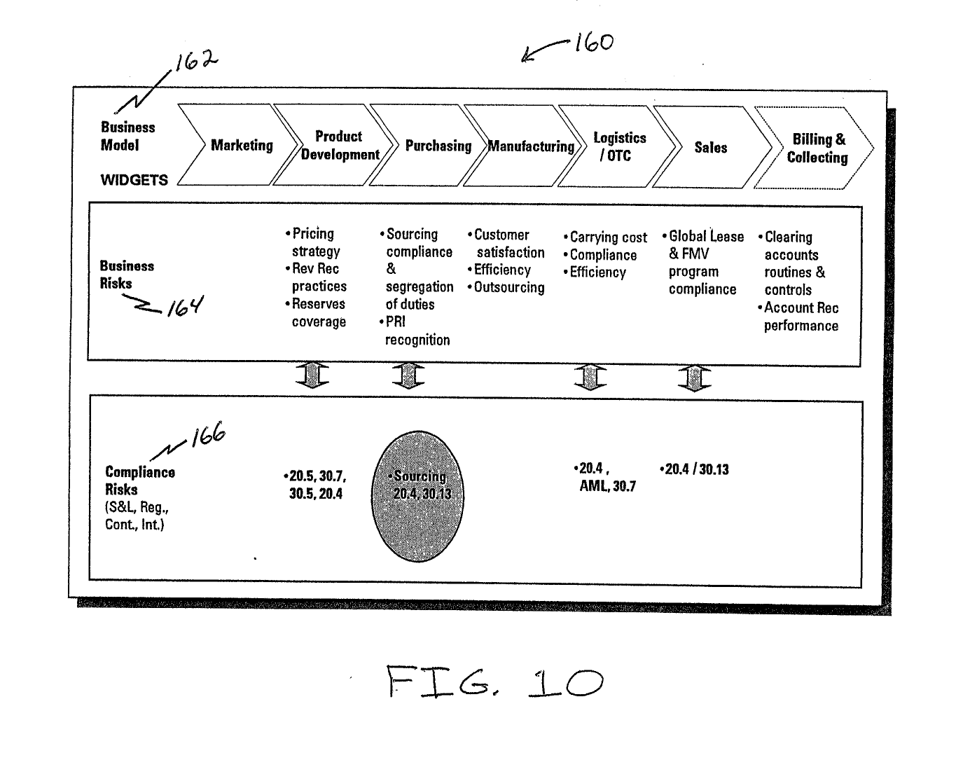

Using the QFD matrix and the prioritized risk areas, the resource team maps a high level business risk model which includes the steps of identifying the business core processes and products such as marketing or billing and collecting, brainstorming the business risks associated with those core processes and products, and associating the business risks with the corresponding compliance requirements and risks. Results from the questionnaires described above are a key input in mapping the high level business risk model. One embodiment of a high-risk business model 160 is shown in FIG. 10. High-risk business model 160 includes, for example, identified steps in business model 162 such as marketing, product development, purchasing, manufacturing, logistics, sales and billing and collecting. Business risks 164 within model 160 include pricing strategy, reserves coverage, revised receivable practices, sourcing compliance and segregation of duties, PRI recognition, customer satisfaction, efficiency, outsourcing, carrying cost, compliance, efficiency, global lease and fair market value program compliance, clearing accounts routines and controls and account receivables performance.

Compliance risks 166, shown in FIG. 10, include, but are not limited to risks associated with not meeting or complying with Spirit and Letter, Regulatory, Contractual and Internal Policy. Spirit and Letter is a very broad area and covers the requirements imposed by law as well as philosophies and moral values that are enforced by the corporate leadership in managing day to day business. Spirit and Letter summarizes each business policy and details each policy's requirements. Compliance areas included within the Spirit and Letter are, but not limited to, are equal employment opportunity, health, safety, environment, anti-trust, ethical business practices, international trade controls, working with government agencies, conflicts of interest, insider trading, financial controls, anti-money laundering, intellectual property and supplier agreements. Regulatory compliance areas include, for example, governmental regulatory agencies, such as, Food and Drug Administration, and other agencies with environmental, labor and safety regulatory authority. Contractual compliance areas include, for example, supplier agreements, indirect sales contracts, customer contracts, union/work council contracts, confidentiality agreements and employee contracts. Internal policy compliance includes, for example, new product introduction, product promotions, pricing discounts and expense approvals.

In FIG. 10, next to compliance risks 166, the specific policy numbers are identified. These policy numbers are also cross-referenced appropriately in FIGS. 9, 11, 12 and 13. For example, Policy Number 20.4 refers to “Ethical Business Practices”, Policy Number 20.5 refers to “Complying with the Antitrust Laws”, Policy Number 30.5 refers to “Avoiding Conflicts of Interest”, Policy Number 30.7 refers to “Financial Controls & Records” and Policy Number 30.13 refers to “Supplier Relationships”. Other policies that are referenced are, Policy Numbers 20.2 Equal Employment Opportunity, 20.3 Health, Safety & Environmental Protection, 20.9 Following International Trade Controls, 20.10 Working with Government Agencies, 20.12 Prohibition on Business with South Africa, 20.13 Insider Trading & Stock Tipping, and 30.9 Participation in Hazardous Business. Each of these policies are described in detail in internal business documents and also summarized in “the Spirit & the Letter of Our Commitment” (incorporated by reference).

Subsequently, a list of compliance requirements is compiled and prioritized by the resource team. The list of compliance requirements is compiled and prioritized by using and adding to database 18 stored on server 12 (shown in FIGS. 1 and 2). Database 18 includes, for example, the core compliance areas within the business' declared policies and procedures (referred to as the business Spirit and Letter), regulatory and legal requirements of the business, contractual and internal policy requirements, and compliance risks noted in business risk model 160 (shown in FIG. 10). As described above, the list of compliance requirements also is prioritized. In an exemplary embodiment, the list of compliance requirements is prioritized by the resource team based on the severity rating of non-compliance. Severity ratings are generated using stored and newly added knowledge base information relevant to severity. The knowledge base includes information relating to how a compliance expert, in a worst case scenario situation, would rate damage to the business reputation and/or the financial impact to a business. The knowledge base may be specific to individual business processes and products. For example, when a business reputation is damaged, the severity rating of non-compliance is high when it has a company impact, medium when it has a division impact and low when it has only a regional impact. The list of compliance requirements is organized in accordance with a severity matrix format. Accordingly, in one specific embodiment, the financial impact of non-compliance is rated high when there is an impact greater than ten percent of net income, medium when the impact is greater than five percent, but less than ten percent, of net income, and low when it has an impact affecting less than five percent of net income. Alternatively, different weighting formulas can be used.

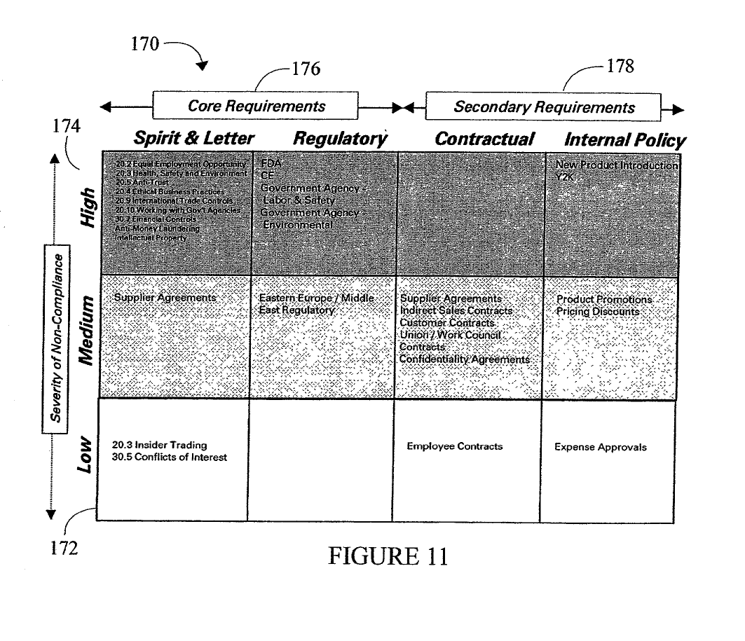

Once the severity rating of each compliance requirement on the list has been rated, the compliance requirements are organized and entered into a severity matrix format stored on server 12. FIG. 11 is an embodiment of a severity matrix 170. The severity rating of non-compliance ranges from a low level 172 of non-compliance to a high level 174 of non-compliance. Both core compliance requirements 176, including spirit and letter and regulatory requirements, and secondary compliance requirements 178, including contractual and internal policy requirements, are prioritized by the resource team based on this severity rating scale.

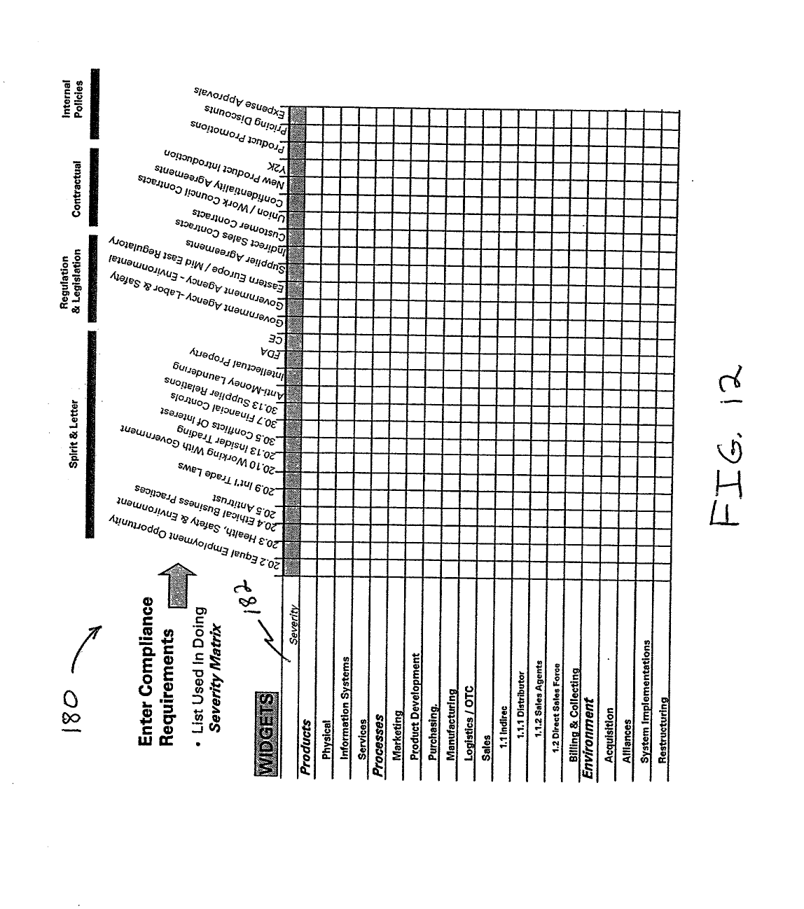

Further, a risk QFD matrix is constructed. FIG. 12 illustrates a risk QFD matrix 180. Risk QFD matrix 180 is constructed using information gathered in creating business risk model 160 (shown in FIG. 10) and compliance risk requirements list developed in creating severity matrix 170 (shown in FIG. 11). Risk QFD matrix 180 includes, for example, the business products, processes and environment and is stored within server 12.

The severity rating for non-compliance of each compliance requirement is entered into risk QFD matrix 180. The severity rating may be any known severity rating. In one specific embodiment, the numerical value that is entered into risk QFD matrix 180 is entered into a top row 182 labeled “SEVERITY.” The numerical value is based upon the damage to reputation and/or financial scores. In the one specific embodiment, a value of ten signifies damage to the reputation of the company or financial impact affecting more than ten percent of net income. A value of five signifies damage to the reputation to the business or financial impact affecting more than five percent but less than ten percent of net income. A value of one means damage to the reputation to the business region or financial impact affecting less than five percent of net income. A value of zero denotes no damage to reputation or any financial impact. Alternatively, different weighting formulas can be used.

Further, the process strength of a business routines and controls is assessed to ensure compliance with each policy. In one specific embodiment, the assessment is accomplished by rating, or quantifying, the strength of the compliance routines and controls to ensure compliance with the policy. The process strength rating may be accomplished by any known rating system. In one specific embodiment, a score of ten means that there is no process or no level of policy awareness. A score of seven indicates an inconsistent process, no documentation or sporadic, ad hoc generic training. A score of three means that there is no enforced process, limited enforced process or no regular specific training. A score of zero means that there is no interaction or no process is necessary. This score is used to calculate a QFD score for quantifying the results.

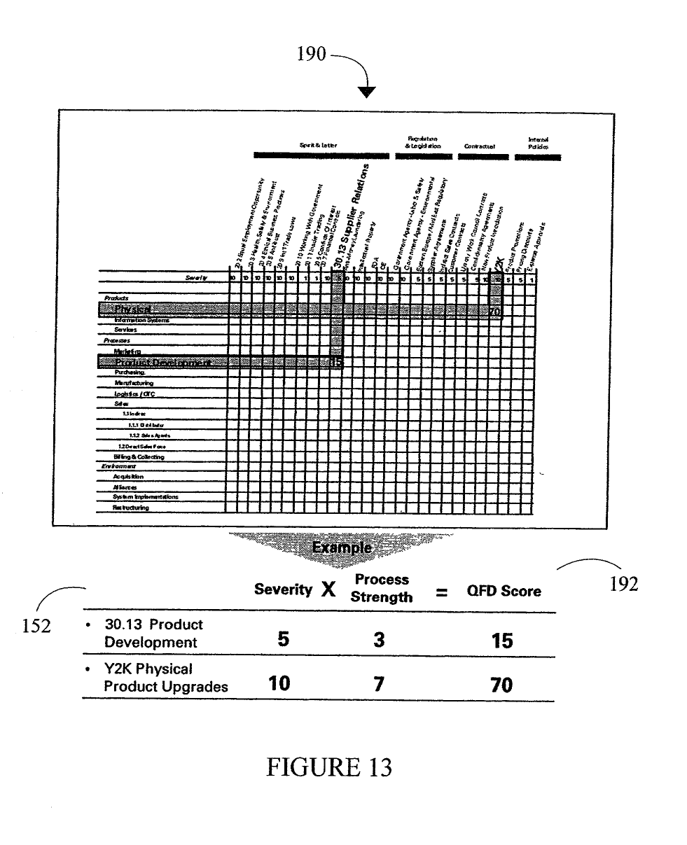

The score is then entered into risk QFD matrix 180. FIG. 13 illustrates one embodiment of a completed risk QFD matrix 190 including a QFD score 192. The QFD score 192 may be calculated by any known method. In one specific embodiment, server 12 is configured to calculate the QFD score as:

severity rating×process strength rating.

The QFD score 192 is entered for each policy compliance area 152. The QFD score 192 is also used for identifying the immediate risks to the business. The higher the QFD score 192, the more immediate the risk to the business.

Once the immediate risks have been identified, the findings are summarized from risk QFD matrix 180 (shown in FIG. 12) in accordance with a risk prioritization matrix. The findings are summarized based on risk criteria and process strength controls. First, the findings are summarized in the risk prioritization matrix (RPM) using the standard template. Next, the risk QFD score 192 guides the placement of the risks into the RPM. In one specific embodiment, qualitative input from counsel is included to translate those results that are not as clear cut as numbers from the risk QFD score 192. These findings are then listed in the available space on the RPM. Once the RPM is completed, it is reviewed with compliance and functional leaders. The top three to five compliance requirements having the highest risks in the RPM are, for example, automatically identified to drive corrective actions.

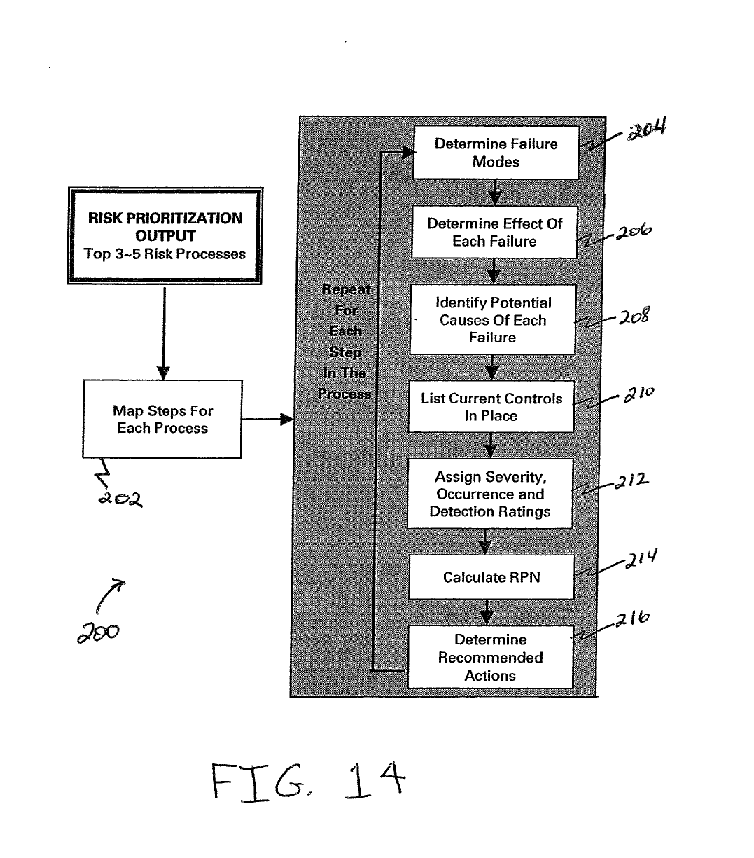

Also, issues relating to risk are identified, for example, determination of potential failures and root causes of the failures. The cross functional resource team is reassembled in order to execute extensive failure mode and effects analysis (FMEA) on the top three to five compliance requirements risks identified in the RPM above. Referring to FIG. 14, a flowchart 200 illustrating process steps executed in addressing the top three to five compliance requirements risks identified in the RPM is shown. After mapping 202 steps for each risk, for example by giving each process step in the risk a name that clearly identifies the step, the risks are analyzed by the team to determine 204 potential failure modes. The effect of each failure mode is determined 206 by the team who then try to identify 208 the potential causes of each failure mode. The high-risk process steps are mapped 202 and a failure mode and effects analysis matrix (FMEA) is constructed. In constructing the FMEA a severity rating, current controls in place are listed 210, a likelihood of occurrence factor and a detection ability factor is assigned 212 based on a standard rating system which is part of the knowledge base in server 12. Server 12 is configured to use the rating system and the entered factors to calculate 214 risk prioritization numbers (RPNs). Next, recommended actions to reduce RPNs are determined 216 by the team. Specifically, and in one embodiment, a RPN enables the team to prioritize actions for implementation and allocate resources effectively to reduce the RPN. In a specific embodiment, progress in reducing an RPN is monitored and team actions are guided by system 10 using the knowledge base stored within server 12.

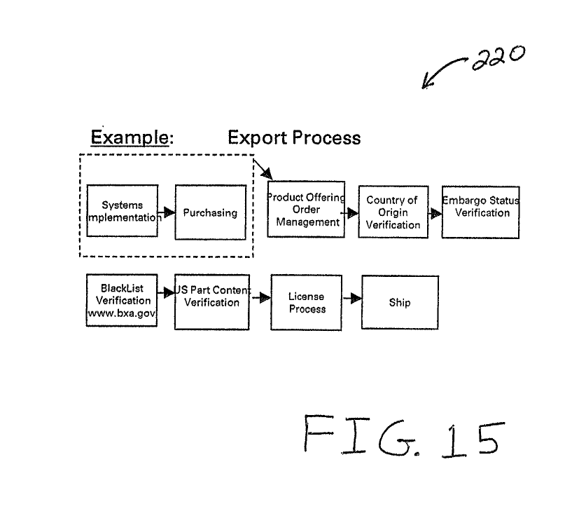

The high-risk process steps also are mapped. The high-risk process steps are mapped in any manner known in the art. In one embodiment, the high-risk process steps are mapped in accordance with a process map. FIG. 15 is an embodiment of a process map 220. In process map 220, every business process is broken down into its discrete steps creating a flowchart.

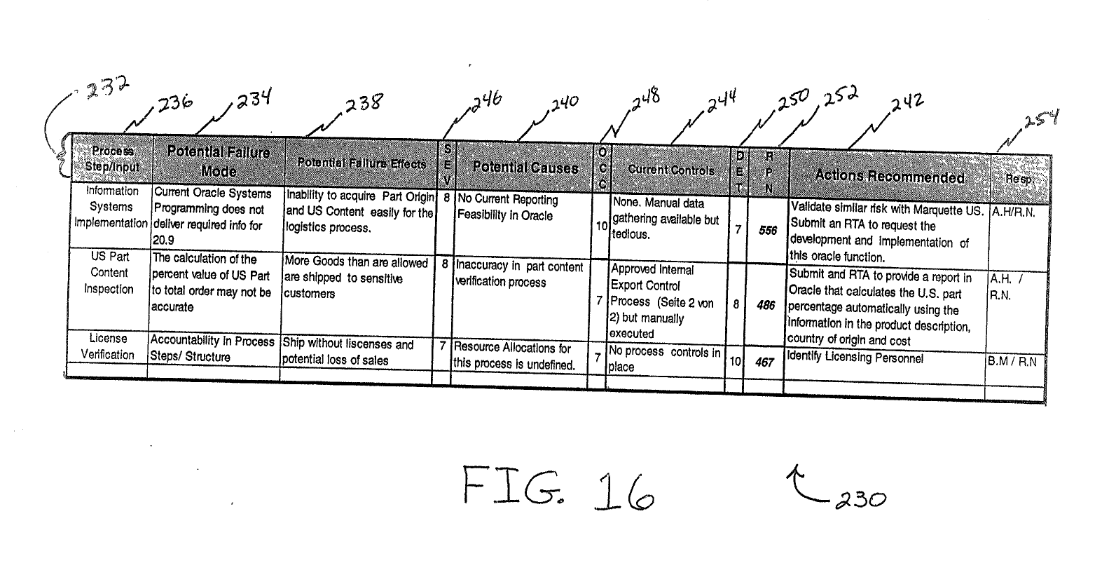

A FMEA provides a consistent and quantifiable approach to identifying potential compliance breakdowns. FIG. 16 illustrates one embodiment of a FMEA 230. At the beginning of construction, the first four columns 232 of FMEA 230 are completed. Columns 232 may include any information relevant to prioritizing the risk of non-compliance. Columns 232 include, for example, a potential failure modes column 234, a steps in the process map column 236, a potential failure effects column 238, a potential causes of the failures column 240, a recommended actions column 242, and a current controls column 244. In potential failure mode column 234, for each step in the process map, potential failure modes are determined and entered. In the potential failure effects column 238, the results of brainstorming potential effects of those potential failure modes are listed. In the potential cause column 240, the potential causes of those failures are identified and listed. In the current controls column 244, the current controls in place to prevent or control the potential failures are listed.

Severity rating, occurrence and detection factors previously assigned 212 (shown in FIG. 14), also are part of FMEA matrix 230. In one embodiment, the severity-rating for the QFD matrix during prioritization of the risk is entered into a severity rating column 246 in FMEA matrix 230. Then, the values for occurrence and detection are calculated using any standard rating system. In one embodiment, the standard rating system includes values from one to ten. An occurrence factor measures the likelihood of occurrence of non-compliance. The likelihood of occurrence measures the frequency of non-compliance in the process with a value of one indicating a remote likelihood up to a value of ten representing that failure is assured. The ability to detect (detection) uses a similar numerical scheme with a value of one meaning that if there is noncompliance, the potential failure will be found or prevented to a value of ten representing absolute certainty that current controls will not detect potential failures or there are no controls in place. The severity rating, occurrence and detection factors are then entered into the FMEA matrix 230 under a severity column 246, an occurrence column 248, and a detection factor column 250 respectively.

As used herein, the RPN is a numerical calculation that represents the relative compliance risk of a particular failure mode. RPN facilitates prioritization of actions for implementation of action and effective allocation of company resources. In one specific embodiment, server 12 is configured to calculate RPN as:

severity rating×occurrence rating×detection rating.

An RPN is entered into FMEA matrix 230 in an RPN column 252.

Recommended actions needed to reduce the RPN are also defined. In a specific embodiment, this information is entered into FMEA matrix 230 under the actions recommended column 242. An owner and an expected date of completion are also be entered into a responsibility column 254.

In yet another specific embodiment, as recommended actions are completed, there is an automatic reassignment of the ratings and recalculation of the RPNs to determine the proper allocation of company resources.

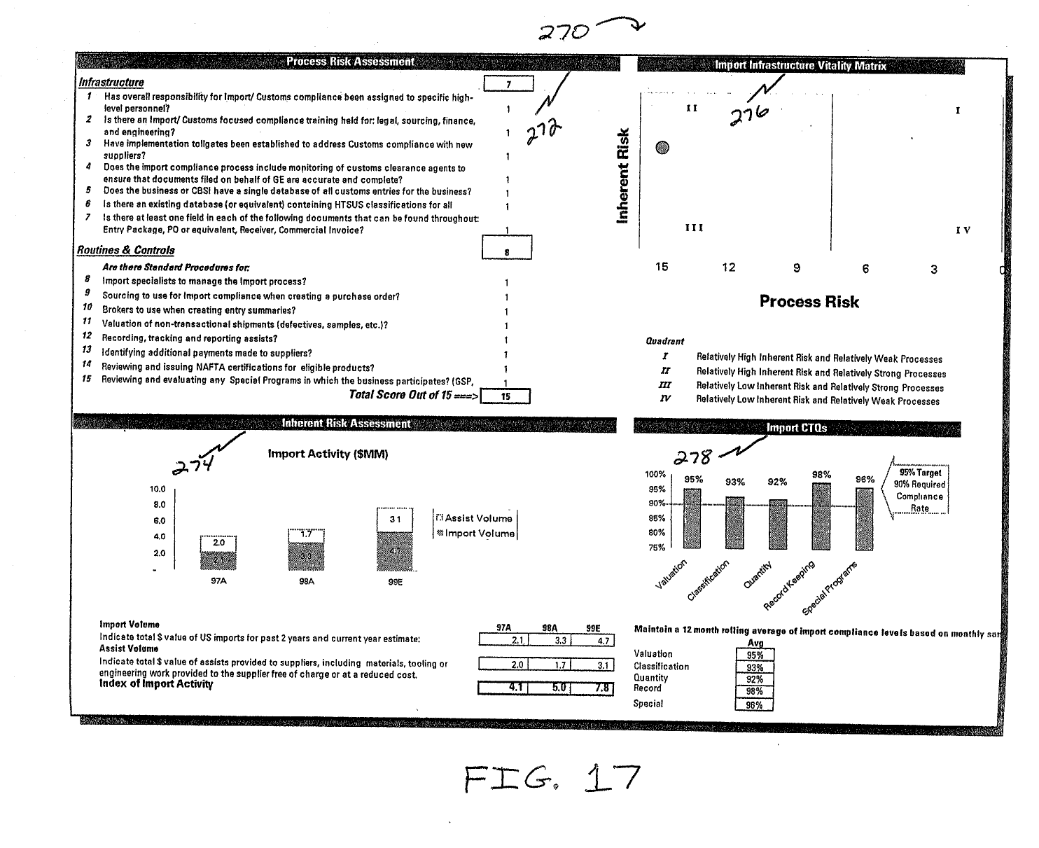

The process in reducing an RPN is monitored. In a specific embodiment, monitoring is accomplished by using policy scorecards. FIG. 17 is an embodiment of a scorecard 270. Scorecards 270 measure capabilities of specific processes. The scorecard formats are stored in server 12 (shown in FIGS. 1 and 2) and are part database 18. Scorecards 270 are business specific and in the embodiment shown in FIG. 17 include information on process risk assessment 272, inherent risk assessment 274, import infrastructure vitality 276 and import CTQs 278. In alternative embodiments, the knowledge base, and thus scorecard 270 may include information relating to specific business guidelines defined by each business. The knowledge base also includes, but is not limited to information received from functional leaders, quality leaders and policy owners. In yet another exemplary embodiment, Inherent Risks are tabulated against Process Risks for organizing and categorizing various risk categories. The objective in tabulating Inherent Risks versus Process Risks is to strategize set of risks in yet another way for better management. Control limits may be set for each business risk based on the type of the risk and the tolerance level that the business can accept.

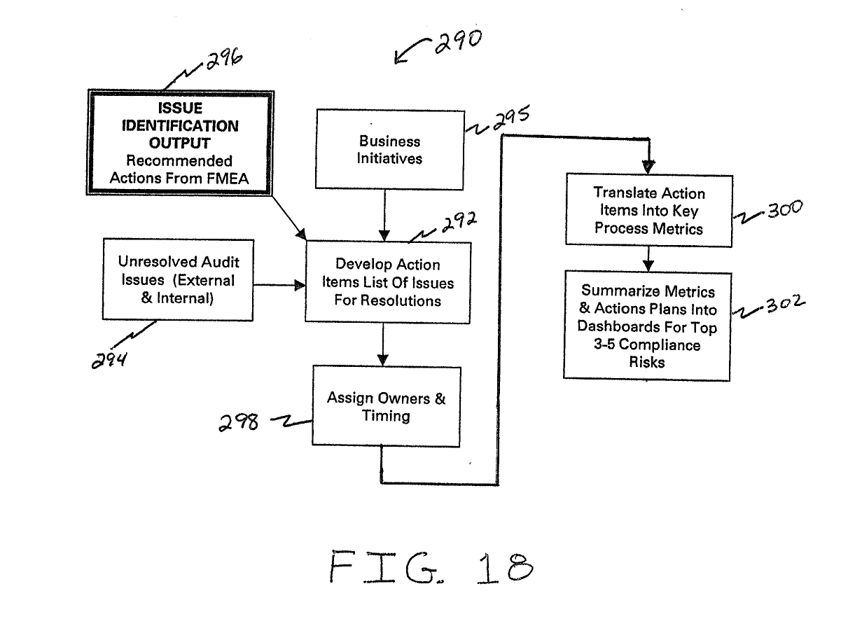

Mitigation and control are used to resolve any risk issues. Mitigation and control is used to ensure that action is taken to resolve risk issues and ensures that controls are put in place to monitor going forward. Referring to FIG. 18, a flowchart for process steps executed in mitigation and control 290 are shown. More specifically, server 12 (shown in FIGS. 1 and 2) is configured to develop 292 an action items list of issues for resolution. The action items list is developed 292 using data within database 18 which also includes any information relevant for resolution of compliance issues and is also stored within server 12. The knowledge base further includes, for example, unresolved external and internal audit issues 294, business initiatives and recommended actions 296 from FMEA matrix 230. After the action items list is developed 292, ownership and timing are assigned 298 using the knowledge base which includes any information relevant to the assignment 298 of an owner or time. The action items are translated 300 into key process metrics and the metrics and actions plans are summarized 302 into dashboards for the top three to five high-risk areas. The dashboards are used as a monitoring and reporting tool.

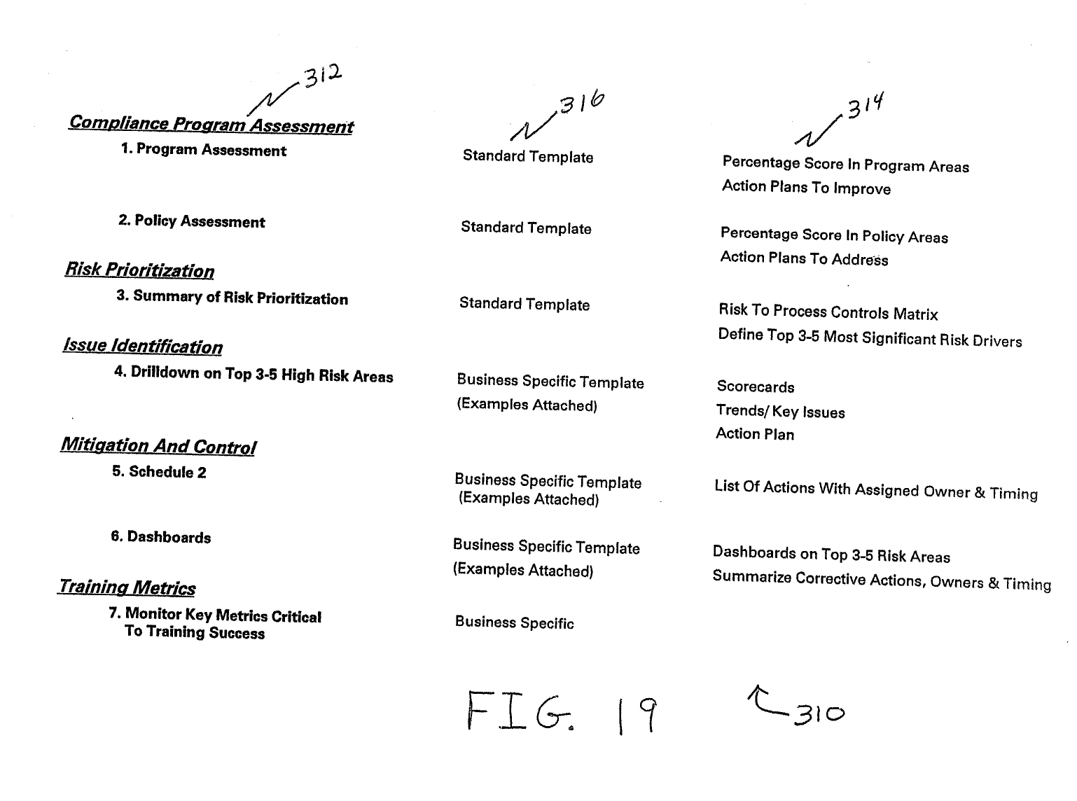

Referring to FIG. 19, one embodiment of an action items list 310 is shown. The action items checklist 310 includes the compliance identification and quantification steps 312 and their respective inputs 314 and templates 316.

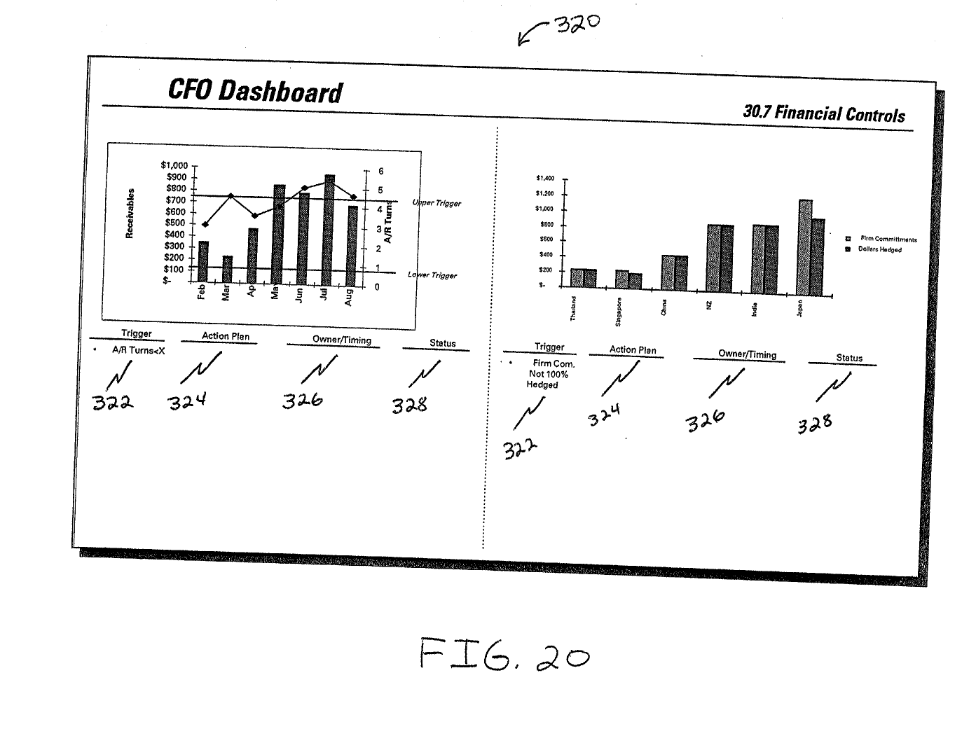

FIG. 20 is an embodiment of a dashboard 320 of the present invention. Dashboard 320, is a scorecard relating to accounts receivable turns and hedged commitments for a Chief Financial Officer (CFO) and includes, but is not limited to triggers 322, action plan information 324, owner/timing information 326 and status information 328.

Compliance issues need to be quickly and effectively by companies in today's environment, however known systems are typically ineffective when identifying and monitoring compliance risks due to a lack of rigor. The above described compliance system implements a network based system where members of a team can identify ownership of issues and identify and quantify risks. Common metrics are used to evaluate and monitor trends in compliance and to effect a more consistent and quantifiable process when addressing compliance issues.

While the invention has been described in terms of various specific embodiments, those skilled in the art will recognize that the invention can be practiced with modification within the spirit and scope of the claims.

What is claimed is:

1. A method for conducting a consistent, documented and yet repeatable compliance risk assessment and mitigation process, using a network-based system including a server system coupled to a centralized database and at least one client system, said method comprising the steps of:
conducting a compliance program assessment;
conducting a prioritization of compliance risks;
identifying, for each compliance risk area, potential compliance failures and potential causes and effects of such compliance failures; and
ensuring that risk monitoring and control mechanisms are in place to mitigate compliance risks.

2. A method according to claim 1 wherein said step of conducting a compliance program assessment further comprises the steps of:
developing a binary questionnaire;
assembling a cross functional team;
defining what constitutes a “yes” answer for each question in the binary questionnaire;
identifying and interviewing process owners for the questionnaire answers;
compiling interview results; and
summarizing findings and reviewing final results with compliance and functional leaders.

3. A method according to claim 1 wherein said step of conducting a prioritization of compliance risks further comprises the steps of:
identifying the compliance risks of at least one of business' processes, products, environment, and location; and
prioritizing the business' highest risks.

4. A method according to claim 1 wherein said step of identifying further comprises the steps of:
analyzing identified high compliance risk areas to determine potential compliance failures and root causes; and
prioritizing actions that need to be taken; and
developing policy scorecards to be used as a monitoring and reporting tool.

5. A method according to claim 1 wherein said step of identifying further comprises the steps of:
reassembling the cross functional team that was initially used to conduct the compliance program assessment;
mapping high risk process steps;
beginning a construction of a Failure Mode in Effect Analysis (FEMA);
assigning severity, occurrence and detection Factors;
calculating Risk Prioritization Numbers (RPN);
defining recommended actions to reduce RPNs; and
defining scorecard content and format.

6. A method according to claim 1 wherein said step of ensuring that risk monitoring and control mechanisms are in place, further comprises the steps of:
establishing appropriate controls to provide guidance to the business; and
monitoring that the appropriate controls to mitigate compliance risks.

7. A method according to claim 1 wherein said step of ensuring that risk monitoring and control mechanisms are in place, further comprises the steps of:
developing action items;
ensuring that the developed action items are completed in a timely manner; and
establishing and monitoring the controls to mitigate compliance risks.

8. A method according to claim 2 wherein said step of identifying and interviewing process owners further comprises the steps of:
identifying and interviewing for compliance using a knowledge base; and
identifying and interviewing for compliance using a question owner's matrix.

9. A method according to claim 2 wherein said step of compiling interview results further comprises the step of compiling interview results using a spreadsheet configured for automatically converting the results from qualitative to quantitative and further configured to tabulate and graph the results.

10. A method according to claim 2 wherein said step of summarizing findings further comprises the step of summarizing the results of the assessment of at least one compliance program using at least one of a program assessment summary and a policy assessment summary.

11. A method according to claim 3 wherein said step of prioritizing the business' highest risk further comprises:
mapping a high level business risk model;
compiling a list of compliance requirements;
prioritizing the list of compliance requirements;
beginning construction of a quality function deployment (QFD);
entering a severity rating for non-compliance with requirements;
assessing and evaluating compliance policies;
identifying immediate risks and completing constructing of a QFD; and
prioritizing compliance risk areas.

12. A method according to claim 11 wherein said step of mapping the high level business risk model further comprises the steps of:
identifying core processes and products of a business;
associating business risk with the core processes and products of a business; and
associating business risk with compliance requirements.

13. A method according to claim 11 wherein said step of compiling a list of compliance requirements further comprises the step of compiling a list of compliance requirements including at least one of a company declared policy and/or practice, legal and regulatory requirements of a business, contractual requirements, compliance risks and internal requirements.

14. A method according to claim 11 wherein said step of prioritizing the list of compliance requirements further comprises prioritizing the severity level of non-compliance using a severity matrix.

15. A method according to claim 11 wherein said step of beginning construction of the quality function deployment (QFD) further comprises the steps of:
beginning construction of the QFD using information generated in mapping the high level business risk model with a compliance requirements list developed in making a severity matrix; and
quantifying the results using a risk QFD matrix.

16. A method according to claim 11 wherein said step of assessing and valuating compliance policies further comprises the steps of:
assessing business routines and controls to ensure compliance with each policy; and
determining a quality function deployment (QFD) score.

17. A method according to claim 16 wherein said step of determining a quality function deployment (QFD) score further comprises the step of determining a QFD score as
process strength rating×severity rating.

18. A method according to claim 16 wherein said step of determining a quality function deployment (QFD) score further comprises automatically entering the score into a risk QFD.

19. A method according to claim 11 wherein said step of prioritizing risk areas further comprises summarizing findings from the risk quality function deployment (QFD) using a risk prioritization matrix.

20. A method according to claim 11 further comprising the step of identifying the top three to five compliance requirements having the highest risk.

21. A method according to claim 5 wherein said step of mapping the high-risk process steps comprises the steps of:
creating a process map; and
creating a process map within a failure mode and effect analysis matrix.

22. A method according to claim 5 wherein said step of beginning the construction of a failure mode and effect analysis matrix further comprises the steps of determining potential failure modes for each step in a process, brainstorming potential effects of the failure identifying potential causes of the failures and documenting current controls.

23. A method according to claim 5 wherein said step of assigning severity, occurrence and detection factors further comprises automatically entering the assigned factors into the failure mode and effect analysis matrix.

24. A method according to claim 5 wherein said step of determining risk prioritization numbers further comprises determining the risk prioritization numbers as
severity rating×occurrence rating×detection rating.

25. A method according to claim 5 wherein said step of defining recommended actions to reduce the risk prioritization numbers further includes the step of automatically entering at least one of the recommended actions, an owner of the recommended action and expected date of completion of the recommended action into the failure mode and effect analysis matrix.

26. A method according to claim 5 wherein said step of defining recommended actions to reduce the risk prioritization number further comprises the steps of automatically reassigning ratings and redetermining the risk prioritization numbers.

27. A method according to claim 5 further comprising the step of monitoring progress in reducing the risk prioritization numbers.

28. A method according to claim 27 wherein the step of monitoring progress in reducing the risk prioritization numbers comprises monitoring progress in reducing the risk prioritization numbers using policy scorecards.

29. A method according to claim 1 further comprising the steps of compiling an actions items list and creating at least one policy dashboard.

30. A method according to claim 1 further comprising the step of monitoring metrics relating to training.

31. A system for identifying and quantifying compliance comprising:
at least one computer;
a server configured to read input information relating to identifying and quantifying compliance, assess at least one compliance program, prioritize risk, identify issues relating to the risk and mitigate and control to resolve the issues;
a network connecting said computer to said server; and
a user interface allowing a user to input information relating to identifying and quantifying compliance.

32. A system according to claim 31 wherein said server configured to assess at least one compliance program is further configured to assemble a cross function team, identify and interview for compliance, compile interview results and summarize the results of the assessment of at least one compliance program.

33. A system according to claim 32 wherein said server configured to assemble a cross-functional team is configured to assemble a cross-functional team using a knowledge base within said server.

34. A system according to claim 32 wherein said server configured to assemble a cross-functional team using a knowledge base is further configured to create a questionnaire that includes a plurality of binary questions relating to compliance and define what constitutes an affirmative answer to the questions.

35. A system according to claim 32 wherein said server configured to identify and interview for compliance is configured to identify and interview for compliance using a knowledge base within said server.

36. A system according to claim 35 wherein said server configured to identify and interview for compliance is further configured to identify and interview for compliance using a question owner's matrix.

37. A system according to claim 32 wherein said server configured to compile interview results using a spreadsheet is configured to compile interview results using a spreadsheet configured for automatically converting results from qualitative to quantitative and to tabulate and graph results.

38. A system according to claim 32 wherein said server configured to summarize the results of the assessment is configured to summarize the results of the assessment using at least one of a program assessment summary and a policy assessment summary.

39. A system according to claim 31 wherein said server configured to prioritize the risk is further configured to map a high level business risk model, compile a list of compliance requirements, prioritize the list of compliance requirements, construct a quality function deployment (QFD) matrix, assign a severity rating for non-compliance with requirements, assess and valuate compliance policies, identify at least one immediate risk and prioritize compliance risks areas.

40. A system according to claim 39 wherein said server configured to map the high level business risk model is further configured to identify at least one core process and product of a business, associate business risk with at least one core process and product of a business and associate business risk with compliance requirements.

41. A system according to claim 39 wherein said server configured to compile a list of compliance requirements is configured to compile a list of compliance requirements including at least one of a company declared policy and/or practice, legal and regulatory requirements of a business, contractual requirements, compliance risks and internal requirements.

42. A system according to claim 39 wherein said server configured to prioritize the list of company requirements is configured to prioritize the severity level of each occurrence of non-compliance in accordance with a severity matrix.

43. A system according to claim 39 wherein said server configured to construct the quality function deployment (QFD) matrix is further configured to construct the QFD matrix using information generated in mapping the high level business risk model with the compliance requirements list developed in creating a severity matrix.

44. A system according to claim 39 wherein said server configured to construct the quality function deployment (QFD) matrix is configured to quantify results using a risk QFD matrix.

45. A system according to claim 39 wherein said server configured to assess and evaluate compliance policies is configured to assess business routines and controls to ensure compliance with each policy and determine a quality function deployment (QFD) score.

46. A system according to claim 45 wherein said server configured to determine a quality function deployment (QFD) score is configured determine a QFD score as
process strength rating×severity rating.

47. A system according to claim 45 wherein said server configured to determine a quality function deployment (QFD) score is further configured to automatically enter the QFD score into a risk QFD matrix.

48. A system according to claim 39 wherein said server configured to prioritize compliance risk areas is further configured to summarize findings from the risk quality function deployment (QFD) matrix in accordance with a risk prioritization matrix.

49. A system according to claim 39 wherein said server is further configured to identify the top three to five compliance requirements having the highest risk.

50. A system according to claim 31 wherein said server configured to identify issues relating to risk is further configured to assemble a cross-functional team, map the high risk process steps, construct a failure mode and effect analysis matrix, assign severity, occurrence and detection factors, determine risk prioritization numbers and define recommended actions to reduce the risk prioritization numbers.

51. A system according to claim 50 wherein said server configured to map the high-risk process steps is further configured to create a process map.

52. A system according to claim 50 wherein said server configured to create a process map is configured to create a process map in accordance with a failure mode and effect analysis matrix.

53. A system according to claim 50 wherein said server configured to construct a failure mode and effect analysis matrix is further configured to determine potential failure modes for each step in a process, brainstorm potential effects of the failures to identify potential causes of the failures and documents current controls.

54. A system according to claim 50 wherein said server configured to determine risk prioritization number is configured to determine risk prioritization numbers as
severity rating×occurrence rating×detection rating.

55. A system according to claim 50 wherein said server configured to assign a severity rating, occurrence and detection factors is further configured to enter the assigned factors into the failure mode and effect analysis matrix.

56. A system according to claim 50 wherein said server configured to define recommended actions is further configured to automatically enter at least one of the recommended actions, an owner of the recommended action, and expected date of completion of the recommended action into the failure mode and effect analysis matrix.

57. A system according to claim 50 wherein said server configured to define recommended actions to reduce the risk of prioritization numbers is further configured to reassign ratings and redetermine the risk prioritization numbers.

58. A system according to claim 50 wherein said server is further configured to monitor progress in reducing the risk prioritization numbers using policy scorecards.

59. A system according to claim 50 wherein said server configured to mitigate is further configured to compile an actions items list and create at least one policy dashboard.

60. A system according to claim 31 wherein said server is configured to allow a user to submit information relating to the identification and quantification of compliance via the Internet.

61. A system according to claim 31 wherein said server is configured to allow a user to submit information relating to the identification and quantification of compliance via an Intranet.

62. A system according to claim 31 wherein said network is one of a wide area network and a local area network.

63. A computer programmed to:
prompt a user to identify potential risks and failure modes and root causes associated with the risks within a compliance program;
prioritize the risks; and
prompt the user with at least one mitigation plan to deal with at least one of the identified risks, failure modes, and root causes.

64. A computer according to claim 63 further programmed to prompt a user to identify process owners within the compliance program.

65. A computer according to claim 63 wherein to identify the risks and failure modes and root causes, said computer displays a computer generated screen comprising a questionnaire relating to compliance.

66. A computer according to claim 65 wherein the questionnaire comprises a question owners matrix.

67. A computer according to claim 66 wherein said question owners matrix comprises a listing of compliance assessment areas.

68. A computer according to claim 63 further programmed to calculate a percentage of compliance.

69. A computer according to claim 65, said computer further programmed to tabulate and graph questionnaire results.

70. A computer according to claim 63 wherein to prompt a user with a mitigation plan, said computer displays a computer generated screen comprising at least one of a completed questionnaire, a summary of current status, improvement opportunities, action plans, potential best practices, a program summary and a policy assessment summary.

71. A computer according to claim 63 wherein to prioritize the risks said computer is programmed to:
assess compliance risk; and
relate risks to processes, products and environments.

72. A computer according to claim 63 wherein to prioritize the risks said computer is programmed to prioritize a list of compliance requirements based upon a severity of non-compliance.

73. A computer according to claim 72 further programmed to organize the list of compliance requirements using a severity matrix format.

74. A computer according to claim 72 further programmed to generate a risk quality function deployment matrix, using compliance requirements and severity ratings for non-compliance of each compliance requirement.

75. A computer according to claim 72 further programmed to calculate risk prioritization numbers using at least one of severity ratings, a likelihood of occurrence factor and a detection ability factor.

76. A computer program embodied on a computer readable medium for managing compliance risk assessment to enable businesses to develop broader and deeper coverage of compliance risks, using a network based system including a server system coupled to a centralized database and at least one client system, said computer program comprising a code segment that:
develops a questionnaire based on list of compliance requirements and stores the questionnaire into a centralized database;
records and processes qualitative responses against each of the questions identified in the questionnaire;
converts the qualitative responses to quantitative results based on predetermined criteria and develops compliance risk assessment output to enable businesses to reduce risks and improve profits.

77. The computer program as recited in claim 76 further comprising a code segment that compiles list of compliance requirements and prioritizes list of compliance requirements based on relative severity of non-compliance.

78. The computer program as recited in claim 77 further comprising a code segment that compiles list of compliance requirements based on at least one of Regulatory Requirements, Contractual Requirements, Internal Policy Requirements and Spirit/Letter Requirements.

79. The computer program as recited in claim 77 further comprising a code segment that:
stores severity rating for non-compliance requirements;
accesses strength of business routines and controls to ensure compliance with each policy;
computes a QFD score; and
prioritizes compliance risk areas according to risk criteria and process control strengths.

80. The computer program as recited in claim 79 further comprising a code segment that links business's core process to key compliance risks.

81. The computer program as recited in claim 76 further comprising a code segment that summarizes findings in an easily readable graphical and table formats.

82. The computer program as recited in claim 79 further comprising a code segment that:
reports progress since last review;
identifies focus areas for next review and defines specific recommended steps that business managers can implement to reduce risks.

83. The computer program as recited in claim 76 further comprising a code segment that generates management reports for at least one of business groups, departments, regions, and countries.

84. The computer program as recited in claim 76 further comprising a code segment that identifies opportunities for each businesses.

85. The computer program as recited in claim 76 wherein the network is a wide area network operable using a protocol including at least one of TCP/IP and IPX.

86. The computer program as recited in claim 76 wherein the data is received from the user via a graphical user interface.

87. The computer program as recited in claim 76 further comprising a code segment that develops questionnaires based on pre-stored assumptions in the database.

88. The computer program as recited in claim 76 wherein the client system and the server system are connected via a network and wherein the network is one of a wide area network, a local area network, an intranet and the Internet.

89. The computer program as recited in claim 76, and further comprising a code segment that monitors the security of the system by restricting access to unauthorized individuals.

90. A database comprising:
data corresponding to identified potential risks;
data corresponding to prioritization of the risks; and
data corresponding to a mitigation and control plan.

91. A database according to claim 90 further comprising data corresponding to a cross-functional team.

92. A database according to claim 90 further comprising data corresponding to a questionnaire regarding compliance.

93. A database according to claim 92 further comprising data corresponding to interview results in a questionnaire spreadsheet.

94. A database according to claim 90 further comprising data corresponding to at least one of a current status summary, improvement opportunities, action plans, potential best practices, a program summary and a policy summary.

95. A database according to claim 90 further comprising data corresponding to a compliance assessment.

96. A database according to claim 90 further comprising data corresponding to a quality function deployment assessment score, the assessment score calculated as process strength rating×severity rating.

97. A database according to claim 90 further comprising data corresponding to a failure mode and effects analysis matrix.

98. A database according to claim 90 further comprising data corresponding to a risk prioritization matrix, risk prioritization calculated as severity rating×occurrence rating×detection rating.

99. A method for compliance assessment comprising the steps of:
entering, into an electronic interface, identified compliance risks and failure modes and root causes associated with the compliance risks;
entering, into the electronic interface, compliance requirements; and
requesting, from the electronic interface, a mitigation and control plan.

100. A method according to claim 99 further comprising the step of entering into the electronic interface, names of a cross-functional team.

101. A method according to claim 100 further comprising the steps of:
requesting cross functional team members to complete a compliance questionnaire; and
requesting, from the electronic interface, a summary of questionnaire results.

102. A method according to claim 101 wherein said step of requesting a summary of questionnaire results further comprises the step of requesting, from the electronic interface, graphed and tabulated results.

103. A method according to claim 99 further comprising the step of requesting, from the electronic interface, prioritization of occurrences of non-compliance in a severity matrix.

104. A method according to claim 99 further comprising the step of requesting, from the electronic interface, an assessment of business routines and controls to determine a quality function deployment (QFD) score.

105. A method according to claim 104 wherein the QFD score is calculated as process strength rating×severity rating.

106. A method according to claim 99 further comprising the step of requesting, from the electronic interface, a failure mode and effects analysis on a number of compliance requirements risks identified in a risk prioritization matrix.

107. A method according to claim 106 wherein the number of compliance requirements risks identified in the risk prioritization matrix is no less than three (3) and no more than five (5).

108. A method according to claim 106 further comprising the steps of:
requesting, from the electronic interface, a risk prioritization number; and
generating a prioritization of actions for implementation and allocation of resources to reduce the risk prioritization number.

109. A method according to claim 108 wherein the risk prioritization number is calculated as severity rating×occurrence rating×detection rating.

110. A method according to claim 108 further comprising the step of monitoring risk prioritization numbers using at least one policy scorecard.

111. A system configured for compliance assessment comprising:
at least one computer;
a server configured to provide a questionnaire which includes a plurality of binary questions relating to a compliance program and a definition of what constitutes an affirmative answer to the questions to identified process owners, compile answers received from the process owners, and summarize the questions and answers as an assessment of the compliance program;
a network connecting said computer to said server; and
a user interface allowing process owners and members of a cross functional team to enter information relating to a compliance assessment.

112. A system according to claim 111 wherein said server further configured provide a question owner's matrix to the process owners.

113. A system according to claim 111 wherein said server further configured to:
automatically convert a compliance assessment from qualitative to quantitative results; and
tabulate and graph the assessment results.

114. A system according to claim 113 wherein said server further configured to tabulate and graph the assessment results using at least one of a program assessment summary and a policy assessment summary.

115. A method for assessing a compliance program, said method comprising the steps of:
assembling a cross-functional team for determining what constitutes compliance;
creating a questionnaire including a plurality of binary questions relating to compliance and defining what constitutes an affirmative answer to the questions;
identifying and interviewing process owners for compliance with the compliance program;
compiling interview results; and
summarizing the results as an assessment of the compliance program.

116. A method according to claim 115 wherein said step of creating a questionnaire comprises the step of generating a question owner's matrix.

117. A method according to claim 115 wherein said step of compiling interview results comprises the steps of:
converting the results from qualitative to quantitative; and
at least one of tabulating and graphing the results.

118. A method according to claim 115 wherein said step of summarizing the results as an assessment of the compliance program comprises the step of using at least one of a program assessment summary and a policy assessment.
